(19) United States
(12) Patent Application Publication
(10) Pub. No.: US 2008/0093818 A1
(43) Pub. Date: Apr. 24, 2008

(54) Independent Suspension System for Mining Vehicle

(76) Inventors: Juha Nykanen, Vantaa (FI); Aleksei Tschurbanoff, Turku (FI)

Correspondence Address: DRINKER BIDDLE & REATH (DC), 1500 K STREET, N.W., SUITE 1100, WASHINGTON, DC, 20005-1209, US

(21) Appl. No.: 11/793,336

(22) PCT Filed: Dec. 19, 2005
(86) PCT No.: PCT/FI05/50465

§ 371 Date: Sep. 12, 2007

(30) Foreign Application Priority Data
Dec. 20, 2004 (FI) 20045493

(51) Int. Cl. B60G 15/12

(52) U.S. Cl. 280/124.159; 280/124.16

(57) ABSTRACT

An independent suspension for a steerable wheel of a mining vehicle and a suspension unit. The wheel of the mining vehicle is mounted to a frame via the suspension unit alone. The suspension unit comprises an outer tube attached to the frame and an inner tube arranged partly inside the outer tube, the hub of the wheel being attached to the lower part of the inner tube. The inner tube may move in a longitudinal direction as required by suspension movements and, further, the inner tube may be rotated about its longitudinal axis to steer the wheel. The suspension unit is further provided with hydropneumatic members for producing suspension movement and dampening.

### BACKGROUND OF THE INVENTION

The invention relates to an independent suspension for a steerable wheel of a mining vehicle, comprising: at least one hub to which at least one wheel is attachable; means for mounting the hub to a frame of the mining vehicle such that the hub is movable in vertical direction and, further, turnable according to steering operations; at least one steering arm for transferring steering force to the hub; and a longitudinal and substantially vertically arranged suspension unit including an inner tube and an outer tube, the inner tube being at the wheel-end of the suspension unit and arranged partly inside the outer tube at the opposite end of the suspension unit for longitudinal movement therein; the suspension unit comprising at least one hydropneumatic suspension and dampening member for receiving and dampening vertical movement of the wheel and the suspension unit including at least two hydraulic pressure fluid chambers separated from one another by a hydraulic piston; and the independent suspension further comprising at least one pressure accumulator; and in which independent suspension the outer tube is attached to the frame so that it is immovable in its longitudinal direction; the inner tube is attached to a steering arm, the inner tube thus being rotatable in relation to the outer tube by a steering force subjected to the steering arm; the hub is attached to the lower end portion of the inner tube; and the hub is mounted to the frame via the suspension unit alone.

The invention further relates to a suspension unit for a mining vehicle wheel, the suspension unit comprising an inner tube and an outer tube, the inner tube being arranged partly inside the outer tube at the opposite end of the suspension unit; the inner tube being movable in a longitudinal direction in relation to the outer tube; the suspension unit comprising at least one hydropneumatic suspension and dampening member for receiving and dampening vertical movement of the wheel, the suspension unit therefore including at least two hydraulic pressure fluid chambers separated from one another by a hydraulic piston, and at least one gas space; and in which suspension unit the lower part of the inner tube is provided with at least one attaching member for attaching the hub of the wheel, the wheel being mountable to the frame of the mining vehicle through the suspension unit alone; and the inner tube is rotatable about its longitudinal axis in relation to the outer tube, whereby the wheel is turnable according to a desired steering operation by subjecting steering force to the inner tube.

The invention further relates to a suspension unit for a mining vehicle wheel, the suspension unit comprising an inner tube and an outer tube, the inner tube being arranged partly inside the outer tube at the opposite end of the suspension unit; the outer tube being movable in a longitudinal direction in relation to the inner tube; the suspension unit comprising at least one hydropneumatic suspension and dampening member for receiving and dampening vertical movement of the wheel, the suspension unit therefore including at least two hydraulic pressure fluid chambers separated from one another by a hydraulic piston, and at least one gas space; and in which suspension unit the lower portion of the outer tube is provided with at least one attaching member for attaching the hub of the wheel, the wheel being mountable to the frame of the mining vehicle via the suspension unit alone; and the outer tube is rotatable about its longitudinal axis in relation to the inner tube, whereby the wheel is turnable according to a desired steering operation by subjecting steering force to the outer tube.

Extremely heavy-duty vehicles are typically used for carrying rock material in mines and excavation sites. For ride comfort and structural stability the wheels of these vehicles are usually provided with suspensions. Such heavy-duty mining vehicles are usually provided with rigid axles. In connection with steerable wheels, a rigid axle must be steerably mounted in relation to the frame. A problem in this arrangement arises from the large space required. Moreover, it is more difficult have an impact on the suspension of an individual wheel mounted to a rigid axle. Vehicle technology also knows independent suspension, which means that each wheel is provided with a suspension of its own attaching it to the frame and thereby allowing it to produce a suspension movement substantially independently of those of the other wheels. In prior art independent suspension arrangements the wheel is mounted to the frame by means of different longitudinal and transverse support arms, wishbone arms, and other support elements. Moreover, such an independent suspension may be provided with a hydropneumatic suspension unit that may comprise a spring providing the wheel with the necessary suspension movement, and also a damper for controlling vertical movements of the wheel. A problem with the prior art independent suspensions is that different support arms and the like require a lot of space.

### BRIEF DISCLOSURE OF THE INVENTION

It is an object of the invention to provide a novel and improved independent suspension and a suspension unit for a steerable wheel of a mining vehicle.

The independent suspension of the invention is characterized in that the upper end portion of the inner tube is provided with a hydraulic piston arranged to move together with the inner tube and sealed against an inner surface of the outer tube; on the upper surface side of the hydraulic piston there is provided a first hydraulic pressure fluid chamber; on the bottom surface side of the hydraulic piston there is provided a second hydraulic pressure fluid chamber; the hydraulic piston is provided with a plural number of openings for leading pressure fluid between the hydraulic pressure fluid chambers; the pressure accumulator comprises a gas space and a gas piston; and the pressure accumulator is arranged inside the inner tube.

The suspension unit of the invention is characterized in that the hydraulic piston is arranged to the upper part of the inner tube; above the hydraulic piston there is provided a first hydraulic pressure fluid chamber; below the hydraulic piston there is provided a second hydraulic pressure fluid chamber; the hydraulic piston is provided with a plural number of openings for leading pressure fluid between the hydraulic pressure fluid chambers; inside the inner tube there is provided a pressure accumulator arranged thereto and battery comprising at least a gas piston and a gas space; the gas piston is arranged to separate the second hydraulic pressure fluid chamber and the gas space from one another; and that the gas piston is arranged to move in the longitudinal direction of the inner tube according to pressures acting on the second hydraulic pressure fluid chamber and the gas space.

The second suspension unit of the invention is characterized in that the hydraulic piston is arranged to the lower part of the inner tube; below the hydraulic piston there is provided a first hydraulic pressure fluid chamber; above the hydraulic piston there is provided a second hydraulic pressure fluid chamber; the hydraulic piston is provided with a plural number of openings for leading pressure fluid between the hydraulic pressure fluid chambers; inside the inner tube there is provided a pressure accumulator arranged thereto and comprising at least a gas piston and a gas space; the gas piston is arranged to separate the second hydraulic pressure fluid chamber and the gas space from one another; and that the gas piston is arranged to move in the longitudinal direction of the inner tube according to pressures acting on the hydraulic pressure fluid chamber and the gas space.

A basic idea of the invention is that a steerable wheel of a mining vehicle is mounted to the frame via a suspension unit alone. The steerable wheel is provided with independent suspensions implemented by means of a hydropneumatic suspension unit comprising spring means to enable the necessary vertical suspension movements and, further, damping means for damping vertical movements. The suspension unit comprises an outer tube immovably attached to the frame. Further, the suspension unit comprises an inner tube the upper part of which is arranged inside the outer tube and which is arranged to move in a longitudinal direction in relation to the outer tube as required by the suspension movements of the wheel. On the lower part of the inner tube there are provided attaching means for attaching the wheel hub to the suspension unit. Further, the inner tube is substantially freely rotatable about its longitudinal axis. Further still, the inner tube is provided with a steering arm attached thereto to allow steering force to be subjected to the inner tube by means of the steering arm, thereby making the inner tube turn in relation to the outer tube. The inner tube and the outer tube may also be arranged contrary to the above, i.e. the inner tube may be attached to the frame, whereas the outer tube together with the wheel hub attached to its lower part are arranged to move in relation to the inner tube during suspension movements and steering operations.

An advantage of the invention is that it provides a simple wheel support implemented by means of a suspension unit alone, without the need for any separate longitudinal or transverse support arms or other similar support structures. Consequently, the suspension unit of the invention requires very little space, whereby it is much easier to arrange to the vehicle chassis structure. Since it fits into a small space, the independent suspension of the invention is most suitable for mining vehicles to be used in underground mines, in which there is limited space available for different components, suspension in particular. Since the wheels are mounted without any separate support members other than the suspensions strut, the wheel mounts is simple in view of both manufacture and servicing. In addition, it is possible to provide the wheel with a relatively large range of suspension movements, because there are no separate support members to restrict its movement.

According to an embodiment of the invention the inner tube comprises a pressure accumulator for storing gas. The pressure accumulator comprises a gas space formed inside the inner tube and a gas piston arranged into the inner space of the inner tube. The gas piston separates the gas space from the hydraulic pressure fluid chamber provided in the hydraulic part of the suspension unit. The upper surface of the gas piston is therefore subjected to a hydraulic pressure, whereas its bottom surface is subjected to a pneumatic pressure. The gas piston inside the inner tube tends to set to a position where the forces caused by the hydraulic pressure and the pneumatic pressure are equal. One of the advantages of the application is that the pressure accumulator is positioned as close as possible to other components associated with the suspension and damping of the suspension unit, and therefore long and complex pressure channels are not required, nor are significant pressure losses created. Further, the pressure accumulator does not increase the outer dimensions of the suspension unit and the inner tube protects it well against shocks and impurities. Further still, it is possible to create a gas space of a sufficiently large volume inside the inner tube.

According to an essential idea of an embodiment of the invention the upper end part of the inner tube is provided with a hydraulic piston attached thereto and arranged to move together with the inner tube. Above the hydraulic piston there is provided a first hydraulic pressure fluid chamber and below the hydraulic piston there is provided a second hydraulic pressure fluid chamber. The hydraulic piston is provided with a plural number of openings through which pressure fluid is arranged to flow from the first hydraulic pressure fluid chamber to the second hydraulic pressure fluid chamber and back, depending on whether the inner tube is moving upwards or downwards. An impact on the volume of the second hydraulic pressure fluid chamber is also exercised by means of the pressure accumulator, which is thus arranged to form a yielding element. The openings in the hydraulic piston throttle the flow of the pressure fluid at least in one direction, thereby dampening the suspension movement.

According to an essential ideal of an embodiment of the invention the hydraulic piston is provided with one or more openings provided with a non-return valve that allows pressure fluid to flow through substantially without flow resistance in a first direction, but blocks flow-through substantially entirely in a second direction. The non-return valve is arranged to allow pressure fluid to flow from the first hydraulic pressure fluid chamber to the second hydraulic pressure fluid chamber, whereby dampers provided in the hydraulic piston are not active when the inner tube moves upwards.

According to an essential idea of an embodiment of the invention both the upward and downward movements of the hydraulic piston are damped by end-cushioning at the extreme positions of the hydraulic piston. End-cushioning allows to avoid oversized loads acting on the suspension unit and other structures of the mining vehicle from being created at the end of an upward or downward suspension movement.

According to an essential idea of an embodiment of the invention the suspension unit is attached to the mining vehicle frame by means of one or more attaching members, such as attaching flanges, provided on the side of the outer tube.

According to an essential idea of the invention the inner tube is provided with at least one connecting element for supplying gas into and releasing it from the inner space of the inner tube. In this case a desired pressure may be set into the pressure accumulator enabling the suspension movements of the suspension unit to be influenced.

According to an essential idea of invention the outer tube is provided with at least one connecting element for supplying pressure fluid into and releasing it from the first hydraulic pressure fluid chamber. By changing the amount of pressure fluid in the suspension unit it is possible to influence the height of the suspension unit, because the supply and removal of the pressure fluid influence the extent to which the inner tube and the outer tube are inside one another.

According to an essential idea of an embodiment of the invention the suspension arrangement is provided with at least one sensor for measuring the height of each suspension unit. Further, the suspension arrangement is provided with at least one control unit configured to receive measurement data from the sensor and to adjust the height of the suspension unit accordingly.

According to an essential idea of an embodiment of the invention a first suspension unit provided on a first side of the mining vehicle and a second suspension unit provided on a second side of the mining vehicle are hydraulically connected to each other. In this case pressure fluid is allowed to flow from the first hydraulic pressure fluid chamber of the first suspension unit to the first hydraulic pressure fluid chamber of the second suspension unit, and vice versa. The pressure spaces are interconnected by a pressure channel provided with means for guiding the pressure fluid flow. This application allows suspensions struts provided on opposite sides of the vehicle to oscillate, whereby the wheels stay in contact with the terrain also on a sloping surface.

### LIST OF THE FIGURES

Some embodiments of the invention will be described in greater detail with reference to the accompanying drawings, in which

FIG. 1 is a schematic view of a heavy-duty mining vehicle the front wheels of which are provided with an independent suspension of the invention;

FIG. 2 is a schematic top view of the steering of wheels provided with the independent suspension of the invention;

FIG. 3 is a schematic view illustrating an independent suspension of the invention applied to steerable wheels of a mining vehicle seen from the front, and also an arrangement enabling wheel oscillation and suspension high adjustment;

FIG. 4 is a schematic sectional view of a suspension unit of the invention;

FIG. 5 is a schematic view of the suspension unit of FIG. 4 seen from direction J.

FIG. 6 is a schematic sectional top view of the suspension unit of FIG. 4 along G-G;

FIG. 7 is another schematic sectional view of the suspension unit of FIG. 4 at H; and

FIG. 8 is a further schematic view of a suspension unit of the invention, in which the inner tube and the outer tube are arranged in a reverse order compared to that in FIGS. 3 to 7.

For the sake of clarity some embodiments of the invention illustrated in the Figures have been simplified. Like parts are indicated with like reference numerals.

### DETAILED DESCRIPTION OF SOME EMBODIMENTS OF THE INVENTION

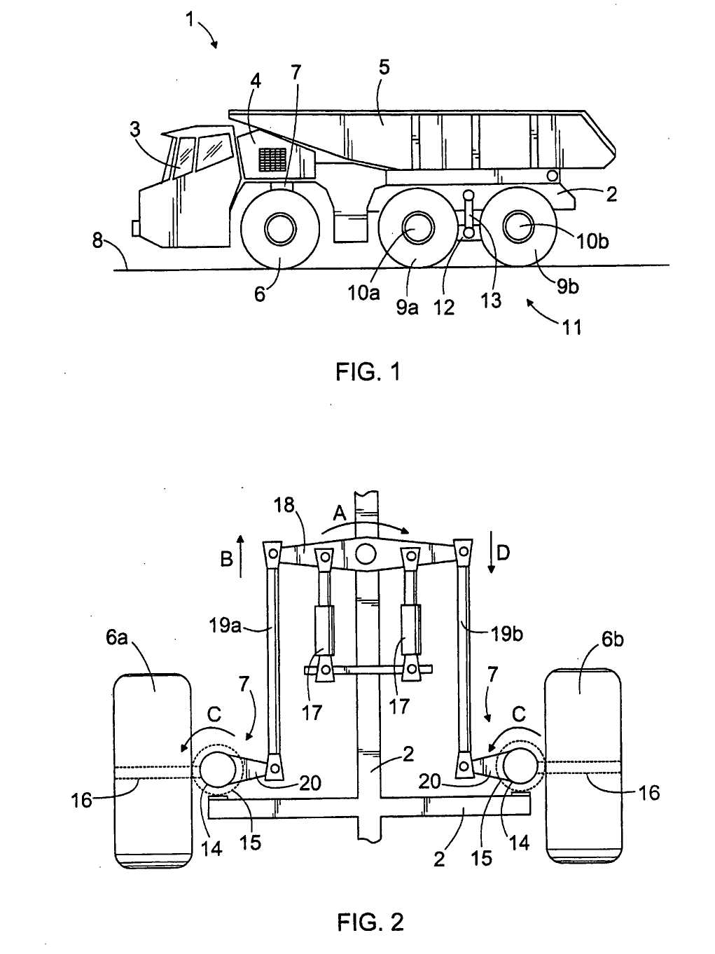

FIG. 1 shows an extremely heavy-duty mining vehicle 1. In this case the mining vehicle 1 is a transport vehicle for carrying broken rock, rock material or loose soil from a loading site to a discharge site in a mine, quarry, or at an excavation site, for example. In addition to transport vehicles, the invention is also applicable to other heavy-duty mining vehicles. The mining vehicle 1 may comprise a frame 2, a cabin 3, an engine unit 4, and a loading platform 5. If the mining vehicle 1 is not a transport vehicle, it may be provided with some other tool, such as a bucket. The mining vehicle 1 may have a plural number of wheels at least some of which are steerable and, further, at least some of which provide traction. The mining vehicle 1 may have two or more steerable front wheels 6 the steering of which allows the vehicle to be steered. Each front wheel 6 may be mounted to the frame 2 via a separate suspension unit 7 so that the front wheels 6 are able to move vertically as required by irregularities and slope of the surface 8. Further, the mining vehicle 1 may be provided with two or more rear wheels 9a, 9b. The mining vehicle 1 may have two rigid rear axles 10a, 10b that form a bogie structure 11 to which the rear wheels 9a, 9b are attached. The rear axles 10a, 10b may be interconnected by means of a horizontal bogie shaft 12. The bogie shaft 12, in turn, may be connected to the frame 2 via a vertical arm 13. The bogie structure 11 may be pivotally arranged for example such that the rearward axle 12b is pivotable in relation to the axle 10a. It is naturally also possible that the mining vehicle 1 is provided with a plural number of successive and/or parallel front wheels 6 and, correspondingly, a plural number of successive rear axles 10 and bogie structures 11. Single wheels, twin wheels, or a desired number of parallel wheels may be provided at the end of the axles 10a, 10b of the bogie structures 11 and, correspondingly, as front wheels.

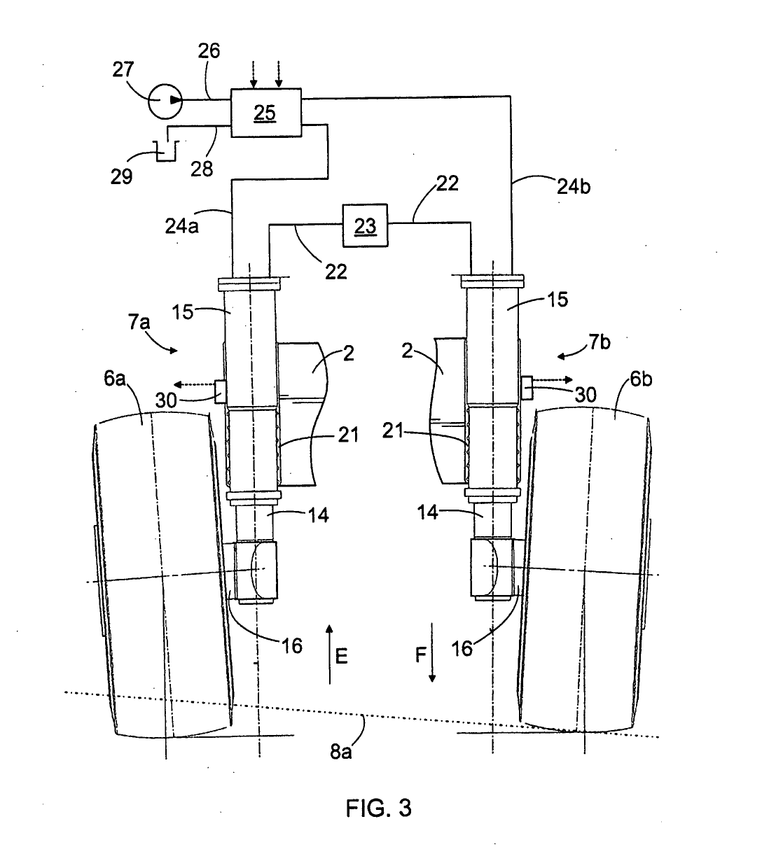

FIG. 2 is a strongly simplified top view of a solution for suspending and steering the front wheels 6a, 6b. Each front wheel 6a, 6b may be mounted to the frame 2 via a separate suspension unit 7 that may comprise an inner tube 14 and an outer tube 15 partly one inside the other, the tubes being depicted in greater detail in FIGS. 3 to 5. The hub 16 of the front wheel 6 is attached to the inner tube 14 at the lower part of the suspension unit 7, the inner tube 14 being rotatable in relation to the outer tube 15 attached to the frame 2. The force needed for steering the front wheels 6a and 6b can be created by means of one or more steering actuators 17 that may be arranged to pivot a pivoting arm 18 articulated to the frame 2. A first end of the pivoting arm 18 may have a first steering rod 19a articulated thereto while a second end of the pivoting arm 18 may have a second steering rod 19b articulated thereto. Further, the steering rod 19a, 19b may be articulated to a steering arm 20 of the suspension unit 7a, 7b, the steering arm transferring the steering force to the inner tube 14 and further through the hub 16 to the wheel 6a, 6b. When the pivoting arm 18 is pivoted in the direction of arrow A, the first steering rod 19a moves forward in the direction of arrow B and makes the front wheel 6a turn in direction C. At the same time the second steering rod 19b moves backward in the direction of arrow D and makes the front wheel 6b turn in direction C.

It should be noted that in this application the suspension unit 7 is examined in its normal operating position, i.e. the upper end of the suspension unit 7 and its components refers to the end facing the frame 2 of the mining vehicle 1 and, correspondingly, the lower end refer to the end facing the wheel 6.

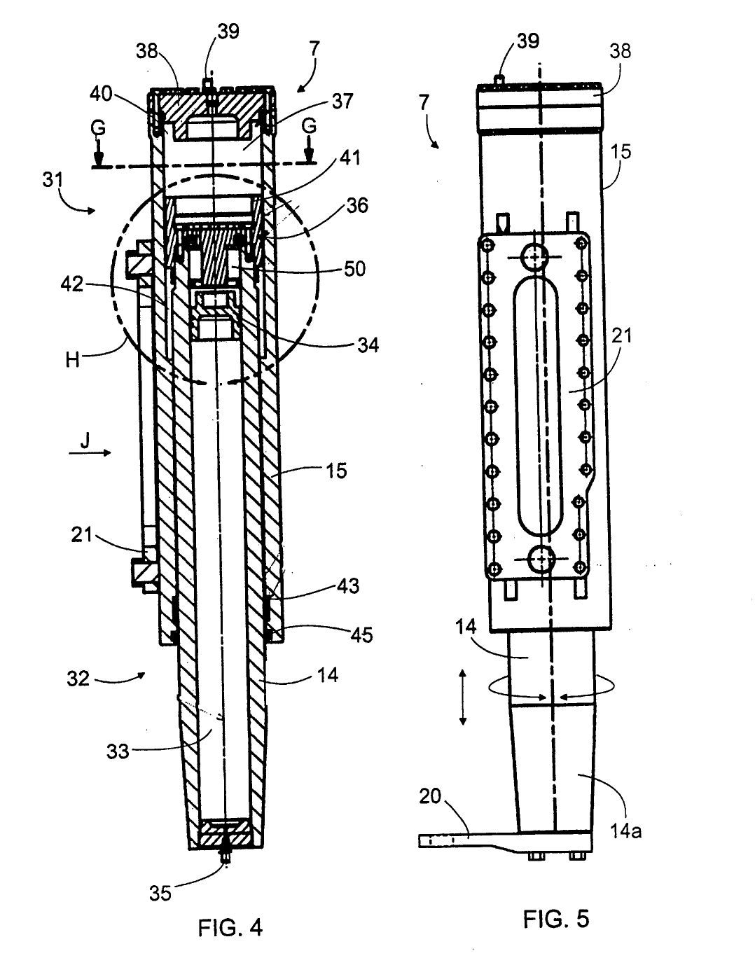

FIG. 3 is a front view of the mining vehicle 1 and illustrates the wheel suspension of the front wheels 6a and 6b. As seen from the Figure, the wheels 6a, 6b are mounted to the frame 2 via the suspension units 7a, 7b alone. Therefore the wheel mount of the invention does not require any complex longitudinal or transverse supports. The hub 16 of the wheel 6a, 6b is attached to the lower end of the inner tube 14. The lower part of the inner tube 14 may be provided with a cone 14a as shown in FIG. 5 or some other fastening member to fasten the hub 16. The inner tube 14 and the outer tube 15 are arranged partly one inside the other, and the inner tube 14 is able to move in relation to the outer tube 15 such that necessary suspension and steering movement are produced. At least the outer surface of the inner tube 14 has a circular cross-section and, correspondingly, at least the inner surface of the outer tube 15 has a circular cross-section to allow the inner tube 14 to rotate about its longitudinal axis while partly inside the outer tube 15. The outer tube 15 may be attached to the frame 3 by a fastening flange 21 provided on the side of the outer tube 15, for example. The suspension unit 7a, 7b may be a combination of a pneumatic spring and a hydraulic damper that enables the necessary suspension movements of the front wheel 6a, 6b and, on the other hand, dampens the suspension movements so that the movements of the wheel 6a, 6b are controlled and stable. In other words, the suspension unit 7a, 7b may be a hydropneumatic device with a hydraulic part at the upper end of the outer tube 15 and a pneumatic pressure accumulator inside the inner tube 14. The construction of the suspension unit 7a, 7b is examined in detail with reference to FIGS. 4 to 7. For the sake of clarity, components associated with the transmission of the steering movement are not shown FIG. 3 at all, but in FIG. 2.

Nevertheless, the operating principle of the suspension units 7a, 7b can be described with reference to FIG. 3. The hydraulic part of the suspension unit 7a of the wheel 6a and the hydraulic part of the suspension unit 7b of the wheel 6b may be interconnected by means of one or more oscillation channels 22. Further, the oscillation channel 22 may be provided with one or more oscillation control units 23 for controlling pressure fluid flows between the suspension units 7a, 7b. The oscillation control unit 23 may comprise for example one or more means for totally blocking the flows, for throttling the flows, or for exercising some other impact on the flows in the oscillation channel 22. Oscillation means that the suspension units 7a, 7b on different sides of the mining vehicle 1 are hydraulically interconnected so that a vertical movement of a wheel on a first side of the vehicle causes a wheel on the other side of the vehicle to produce a vertical movement of an opposite direction. For example, when the vehicle is driven on a sloping surface 8a such as illustrated by a dotted line in FIG. 3, the left front wheel 6a tends to rise in the direction of arrow E, whereby the inner tube 14 penetrates into the outer tube 15 and displaces pressure fluid from the hydraulic part of the suspension unit 7a, which pressure fluid may flow through the oscillation channel 22 and the oscillation control unit 23 to the hydraulic part of the suspension unit 7b on the right-hand side, thereby causing the right-hand side inner tube 14 and the right-hand side front wheel 6b to press towards the inclined surface 8a in the direction of arrow F. Oscillation allows the wheels 6a, 6b to be kept firmly against the surface 8a despite its inclination. This also allows the tilting of the mining vehicle 1 relative to its longitudinal axis to be damped and, consequently, stresses acting on the frame 2 to be reduced. A further advantage of oscillation is that the stresses act substantially evenly on all front wheels and their suspension units 7. In addition, oscillation facilitates the steering of the vehicle. When necessary, oscillation can be locked by closing the oscillation channel 22 between the suspension units 7a, 7b by a valve provided in the control unit 23. This may be necessary in connection with loading or unloading of the vehicle, for example.

FIG. 3 further shows means for adjusting the height of the suspension units 7a, 7b. The hydraulic parts at the upper ends of the suspension units 7a, 7b may be connected via the adjusting channels 24a and 24b to a height control unit 25 that may, in turn, be connected via a pressure fluid channel 26 to a pressure source 27 and, further, via a pressure fluid channel 28 to a pressure fluid container 29. The height of the suspension unit 7a, 7b may be monitored by means of one or more sensors 30 from which measurement data may be transmitted to the height control unit 25, which may actively adjust the height of the suspension units 7a, 7b on the basis of the measurement data and other control data obtained. The height of the suspension of the front wheels 6a, 6b may be kept substantially stable irrespective of the vertical load acting on the suspension units 7a, 7b, which load varies in practice according to the load to be transported. If on the basis of the measurement result obtained from the sensors 30 the control unit 25 detects the front suspension to be below the setting value, due to a heavy load for example, the height control unit 25 may supply pressure fluid from the pressure source 27 to the hydraulic parts of the suspension units 7a, 7b to increase the suspension height. On the other hand, if the measurement result obtained from the sensors 30 shows the front suspension to be higher than the setting value, the control unit 25 may release pressure fluid from the hydraulic parts of the suspension units 7a, 7b to the container 29. The aim may be to keep the height of the suspension units 7a, 7b in the middle of the suspension range, whereby the magnitude of the suspension distance available both upwards and downwards is at its maximum. It should be mentioned that instead of a separate oscillation channel 22 and adjustment channels 23a, 23b, a common pressure medium channel may be used. In addition, the oscillation control unit 23 and the height control unit 25 may be combined into a single whole.

Further, both the front wheels 6a and the rear wheels 6b may be equipped with brakes. In this case the suspension and the wheel supports of the mining vehicle 1 must be designed taking into account braking forces created during braking. The suspension units 7 of the front wheels 6a in particular must be dimensioned to sustain braking forces. The inner tube 14, outer tube 15 and the joint between them must therefore be designed and dimensioned so that they are strong. In addition, all wheels of the vehicle, or some of them, may be drive wheels. The suspension unit of the invention can thus be applied also to the suspension of wheels provided with brakes and traction.

FIG. 4 illustrates a cross-sectional view of the suspension unit 7, and in FIG. 5 the same suspension unit 7 is shown as seen from the direction of arrow J. The suspension unit 7 is a longitudinal piece with a hydraulic part 31 at the upper end thereof and possibly provided with a pneumatic pressure accumulator 32 at its lower end for storing gas, such as compressed air. The pressure accumulator 32 may comprise a gas space 33 that may be formed inside the inner tube 14. Further, the pressure accumulator 32 may be provided with a separating member, such as a gas piston 34 that separates the pneumatic part and the hydraulic part 31 from one another. The gas piston 34 may move in a longitudinal direction inside the inner tube according to the magnitudes of the hydraulic pressure acting on its upper surface and the pneumatic pressure acting on its bottom surface. Since the pressure accumulator 32 is formed inside the inner tube 14, the suspension unit does not necessarily be provided with separate external pressure batteries, but the construction may be compact and well protected against shocks and impurities. The lower end of the inner tube 14 may be provided with a connecting element 35 that can be used to influence the pressure of the gas in the gas space 33. The pressure in the gas space 33 may be pre-set to a certain value. The magnitude of the pressure may be used to influence the spring force of the suspension. In practice the pressure accumulator 32 is used to exercise an impact on the suspension and ride comfort of the mining vehicle 1, when it is driven without load.

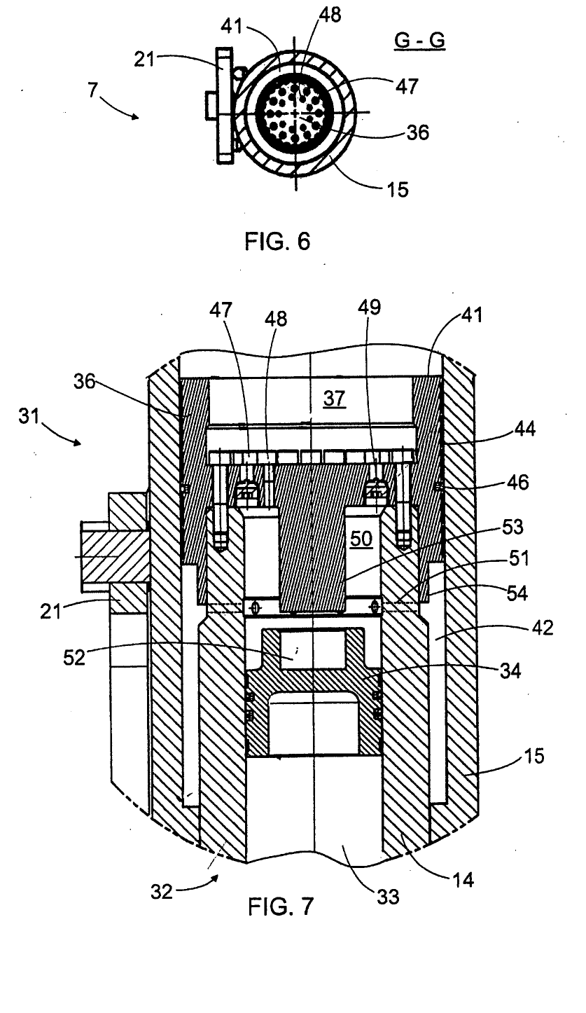

The hydraulic part 31 may comprise a hydraulic piston 36 that may be immovably attached to the upper part of the inner tube 14. The hydraulic piston 36 may provide the upper end of the inner tube with a kind of an end piece that moves inside the outer tube 15 along with the upper end of the inner tube 14. The hydraulic piston 36 may be sealed against the inner surface of the outer tube 15 by means of suitable seals. Above the hydraulic piston 36 there may be a first hydraulic pressure fluid chamber 37 that may be subject to the pressure of the pressure fluid. The upper part of the outer tube 15 may be provided with a cover 38 bounding the first hydraulic pressure fluid chamber 37, and the cover may be further provided with one or more connecting elements 39 for conveying pressure fluid into and out of the pressure space 37 during the above-described oscillation and height adjustment, for example. Further, the cover 38 may be provided with a groove 40 which together with a protruding portion 41 provided on the upper surface of the hydraulic piston 36 may form an end-cushioning for inward suspension movement. The suspension unit 7 may also be provided with an end-cushioning for an outward suspension movement. For this purpose the hydraulic part 31 may be provided with an end-cushioning space 42 that may be bounded by a recess made to the inner surface of the outer tube 15 and located at the hydraulic part 31, the outer surface of the inner tube 14, and the hydraulic piston 36. The end-cushioning of the outward suspension movement and the operation of the hydraulic part will be described in greater detail in connection with FIGS. 6 and 7.

FIG. 4 further shows that the lower end portion of the outer tube 15 may be provided with one or more first sliding pieces 43 for supporting the inner tube 14 to the outer tube 15. Correspondingly, the hydraulic piston 36 may be provided with a second sliding piece 44 for supporting the upper end of the inner tube 14 to the inner surface of the outer tube 15. Further, one or more sealing elements 45 may be provided between the lower end of the outer tube 15 and the inner tube 14, and, in addition, one or more sealing elements 46 in the hydraulic piston 36.

FIG. 6 is a cross-sectional view of a suspension unit 7 taken at the first hydraulic pressure fluid chamber 37. As seen in the Figure, the hydraulic piston 36 may be provided with a plural number of first openings 47 and a plural number of second openings 48. All the first openings 47, or at least some of them, may be provided with a non-return valve 49 seen in FIG. 7. Further, the second openings 48 may free through-holes or openings provided with throttles and they connect the first hydraulic pressure fluid chamber 37 above the hydraulic piston 36 to the second hydraulic pressure fluid chamber 50 below the hydraulic piston 36. By changing the number and the dimensions of the first openings 47 and the second openings 48 and by the choice of the non-return valves 49 it is possible to influence the characteristics of the suspension.

FIG. 7 is a sectional view of a hydraulic part 31 of the suspension unit 7. The piston 36 is provided with openings 47 and 48 connecting the first pressure space 37 to the second pressure space 50. Further, one or more channels 51 provided in the inner tube 14 connect the second pressure space 50 to the end-cushioning space 42. Pushed by the pressure of the gas, the gas piston 34 in the pressure accumulator 32 tends to reduce the volume the second hydraulic pressure fluid chamber 50 and to thereby contribute to the pressure acting in the hydraulic pressure fluid chambers 37, 42, 50. Further, the amount of pressure fluid in the hydraulic pressure fluid chambers can be adjusted by increasing or reducing the amount of pressure fluid supplied through the connecting element 39. When the mining vehicle 1 meets a bump on the surface 8, the wheel 6 rises upward and pushes the inner tube 14 upward. This causes the hydraulic piston 36 at the upper end of the inner tube 14 to displace pressure fluid from the first hydraulic pressure fluid chamber 37, the fluid then flowing through the first openings 47 and second openings 48 in the hydraulic piston 36 into the second hydraulic pressure fluid chamber 50. The non-return valves 49 in the first openings 47 may let the pressure fluid flow through freely from the first hydraulic pressure fluid chamber 37 to the second hydraulic pressure fluid chamber 50. In other words, no effort is made to influence the upward movement of the wheel 6 by means of the damper provided in the suspension unit 7. Instead, the pressure accumulator 32 tends to restrict the upward movement of the wheel. The pressure fluid flowing from the first hydraulic pressure fluid chamber 37 to the second hydraulic pressure fluid chamber 50 is forced to push the gas piston 34 towards the gas space 33. When the mining vehicle 1 is carrying a heavy load, the driving speed is extremely low and therefore suspension is not particularly essential for ride comfort. However, the suspension unit provides at least some suspension movement even to a load-carrying mining vehicle 1. But when the mining vehicle 1 is driven without a load or with a minor load, the pressure accumulator 32 allows a relatively long suspension movement to be produced, thereby providing good riding qualities and ride comfort.

When the inner tube 14 penetrates outward after the suspension movement, pressure fluid flows from the second hydraulic pressure fluid chamber 50 through the second openings 48 in the hydraulic piston into the first hydraulic pressure fluid chamber 37. The second openings 48 are dimensioned to throttle the flow. Alternatively, the second openings 48 are provided with suitable throttles. Since the first openings 47 are provided with non-return valves 49, the pressure fluid cannot flow through the valves in this direction. As a result, the behaviour of the wheel 6 is controlled and it stays in firm contact with the surface 8. If the wheel 6 is driven into a deep hole in the ground, the second end-cushioning element of the suspension unit 7 may receive the movement of the inner tube 14 in a controlled manner to prevent unnecessarily strong loads acting on the construction of the suspension unit 7. The end-cushioning may operate such that an outward movement of the inner tube 14 frees volume in the first hydraulic pressure fluid chamber 37 above the piston 36, thereby allowing pressure fluid to flow from the end-cushioning space 42 and the second hydraulic pressure fluid chamber 50 into the first hydraulic pressure fluid chamber 37. In this case the pressure acting in the gas space 33 may push the gas piston 34 upward. The inner tube 14 may protrude to the extent that a shoulder 54 provided in the hydraulic piston 36 is able to close the channels 51 between the end-cushioning space 42 and the second hydraulic pressure fluid chamber 50. As a result, pressure fluid can no longer flow away from the end-cushioning space 42 through the channels 51, whereby a closed pressure space is created that may stop the outward movement of the inner tube 14 in a controlled manner. Further, the top surface of the gas piston 34 may be provided with a recess 52 and the bottom surface of the hydraulic piston 36 with a protrusion 53. As the gas piston 34 moves upward, the protrusion 53 goes into the recess 52 and together they dampen the movement of the gas piston 34 at its extreme position. This allows also the upward movement of the gas piston 34 to be restricted, whereby contact between the sealing elements of the gas piston 34 and the channels 51 can be avoided.

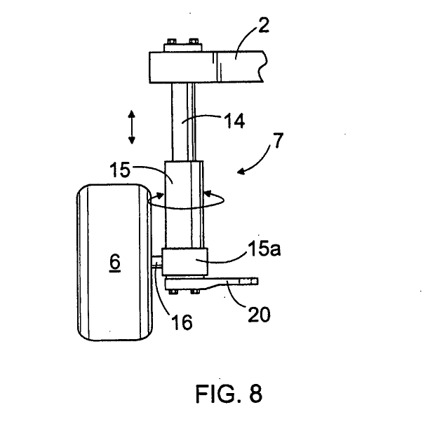

FIG. 8 shows yet a further alternative for suspending a steerable wheel of the mining vehicle 1. In this case the hub 16 of the wheel 6 is fastened to the lower part of the outer tube 15 by means of fastening members 15a. Further, the inner tube 14 is attached substantially immovably to the frame 2 of the mining vehicle 1. The outer tube 15 is thus able to move according to the suspension movements upward and downward in relation to the inner tube 14 as well as to turn in accordance with steering operations in relation to the inner tube 14. The lower part of the outer tube 15 may be provided with a steering arm 20 for transferring steering forces to the outer tube 15. The hydraulic pressure fluid chambers 37 and 50 and the pressure accumulator 32 associated with the hydropneumatic suspension unit 7 may be placed in a corresponding manner to the inner and the outer tube or, alternatively, in some other way, for example in a reverse manner, i.e. the pressure accumulator 32 may be in the outer tube 15 and the hydraulic part in the inner tube 14. Further, the suspension unit 7 of FIG. 8 may comprise means for controlling height, spring force, and wheel oscillation as described in connection with the previous Figures.

Generally, it can be stated that the mining vehicle of the invention has at least one wheel the suspension of which is accomplished by means of a hydropneumatic suspension unit alone. The suspension unit is a longitudinal piece and comprises a first tube and a second tube arranged partly one inside the other. In that case one of the said tubes may be moved in a vertical direction relative to the other tube, the other tube being substantially immovably attached to the mining vehicle frame. The wheel and the wheel hub are connected to the movable tube. In addition, the movable tube may be rotated about its longitudinal axis as required by steering operations.

In some cases the characteristics disclosed in this application may be applied independently, irrespective of other features. On the other hand, if necessary, the characteristics disclosed here may used in varying combinations.

The drawings and the related specification are only meant to illustrate the inventive idea. The details of the invention may vary within the scope of the claims.

1: An independent suspension for a steerable wheel of a mining vehicle, comprising:
at least one hub to which at least one wheel is attachable;
means for mounting the hub to a frame of the mining vehicle such that the hub is movable in vertical direction and, further, turnable according to steering operations;
at least one steering arm for transferring steering force to the hub; and
a longitudinal and substantially vertically arranged suspension unit including an inner tube and an outer tube, the inner tube being at the wheel-end of the suspension unit and arranged partly inside the outer tube at the opposite end of the suspension unit for longitudinal movement therein,
wherein the suspension unit comprises at least one hydropneumatic suspension and dampening member for receiving and dampening vertical movement of the wheel and the suspension unit including at least two hydraulic pressure fluid chambers separated from one another by a hydraulic piston,
at least one pressure accumulator,
the outer tube is attached to the frame so that it is immovable in its longitudinal direction,
the inner tube is attached to a steering arm, the inner tube thus being rotatable in relation to the outer tube by a steering force subjected to the steering arm,
the hub is attached to the lower end portion of the inner tube,
the hub is mounted to the frame via the suspension unit alone,
the upper end portion of the inner tube is provided with a hydraulic piston arranged to move together with the inner tube and sealed against an inner surface of the outer tube,
on the upper surface side of the hydraulic piston there is provided a first hydraulic pressure fluid chamber,
on the bottom surface side of the hydraulic piston there is provided a second hydraulic pressure fluid chamber,
the hydraulic piston is provided with a plural number of openings for leading pressure fluid between the hydraulic pressure fluid chambers,
the pressure accumulator comprises a gas space and a gas piston,
the pressure accumulator is arranged inside the inner tube, and
the hydraulic piston and the gas piston are provided with end-cushioning.

2: An independent suspension according to claim 1, wherein the hydraulic piston comprises a plural number of first openings provided with a non-return valve, whereby pressure fluid flow through the non-return valve is arranged to take place substantially freely from the first hydraulic pressure fluid chamber to the second hydraulic pressure fluid chamber, whereas pressure fluid flow through the non-return valve from the second hydraulic pressure fluid chamber to the first hydraulic pressure fluid chamber is blocked, and
the hydraulic piston comprises a plural number of second openings arranged to throttle pressure fluid flowing from the second hydraulic pressure fluid chamber to the first hydraulic pressure fluid chamber, the hydraulic piston being arranged to dampen the downward movement of the inner tube.

3: An independent suspension according to claim 1, wherein on a first side of the mining vehicle there is provided a first suspension unit and on a second side of the mining vehicle there is provided a second suspension unit, and
the first hydraulic pressure fluid chamber of the first suspension unit and the first hydraulic pressure fluid chamber of the second suspension unit are interconnected via at least one pressure fluid channel, whereby a substantially equal pressure is arranged to act on the first hydraulic pressure fluid chambers.

4: An independent suspension according to claim 1, wherein the first hydraulic pressure fluid chamber of the suspension unit is connected to at least one connecting element, which is in turn connected to at least one pressure fluid channel for supplying pressure fluid to and releasing it from the hydraulic pressure fluid chamber, the height of the suspension unit being thus adjustable by increasing or reducing the amount of pressure fluid in the hydraulic pressure fluid chamber.

5: An independent suspension according to claim 1, wherein the first hydraulic pressure fluid chamber of the suspension unit is connected to at least one connecting element, which is in turn connected to at least one pressure fluid channel for supplying pressure fluid to and releasing it from the hydraulic pressure fluid chamber, the height of the suspension unit being thus adjustable by increasing or reducing the amount of pressure fluid in the hydraulic pressure fluid chamber, and
wherein there is at least one sensor arranged to measure the height of the suspension unit, and
there is at least one control unit arranged to adjust the height of the suspension unit on the basis of the measurement data obtained from the sensor.

6: A suspension unit for a mining vehicle wheel, the suspension unit comprising an inner tube and an outer tube,
the inner tube being arranged partly inside the outer tube at the opposite end of the suspension unit.
the inner tube being movable in a longitudinal direction in relation to the outer tube.
the suspension unit comprising at least one hydropneumatic suspension and dampening member for receiving and dampening vertical movement of the wheel, the suspension unit therefore including at least two hydraulic pressure fluid chambers separated from one another by a hydraulic piston, and at least one gas space,
the lower part of the inner tube is provided with at least one attaching member for attaching the hub of the wheel, the wheel being mountable to the frame of the mining vehicle through the suspension unit alone,
the inner tube is rotatable about its longitudinal axis in relation to the outer tube, whereby the wheel is turnable according to a desired steering operation by subjecting steering force to the inner tube,
the hydraulic piston is arranged to the upper part of the inner tube,
above the hydraulic piston there is provided a first hydraulic pressure fluid chamber,
below the hydraulic piston there is provided a second hydraulic pressure fluid chamber,
the hydraulic piston is provided with a plural number of openings for leading pressure fluid between the hydraulic pressure fluid chambers,
inside the inner tube there is provided a pressure accumulator arranged thereto, the accumulator comprising at least a gas piston and a gas space,
the gas piston is arranged to separate the second hydraulic pressure fluid chamber and the gas space from one another,
the gas piston is arranged to move in the longitudinal direction of the inner tube according to pressures acting on the second hydraulic pressure fluid chamber and the gas space,
and wherein the hydraulic piston and the gas piston are provided with end-cushioning.

7: A suspension unit according to claim 6, wherein the lower part of the inner tube is provided with a steering arm attached thereto for transferring steering force to the inner tube.

8: A suspension unit according to claim 6, wherein on the side of the outer tube there is at least one attaching flange, the suspension unit being thus attachable to the frame of the mining vehicle by means of the attaching flange.

9: A suspension unit for a mining vehicle wheel, the suspension unit comprising an inner tube and an outer tube,
the inner tube being arranged partly inside the outer tube at the opposite end of the suspension unit.
the outer tube being movable in a longitudinal direction in relation to the inner tube,
the suspension unit comprising at least one hydropneumatic suspension and dampening member for receiving and dampening vertical movement of the wheel, the suspension unit therefore including at least two hydraulic pressure fluid chambers separated from one another by a hydraulic piston, and at least one gas space,
the lower portion of the outer tube is provided with at least one attaching member for attaching the hub of the wheel, the wheel being mountable to the frame of the mining vehicle via the suspension unit alone,
the outer tube is rotatable about its longitudinal axis in relation to the inner tube, whereby the wheel is turnable according to a desired steering operation by subjecting steering force to the outer tube,
the hydraulic piston is arranged to the lower part of the inner tube,
below the hydraulic piston there is provided a first hydraulic pressure fluid chamber,
above the hydraulic piston there is provided a second hydraulic pressure fluid chamber.
the hydraulic piston is provided with a plural number of openings for leading pressure fluid between the hydraulic pressure fluid chambers,
inside the inner tube there is provided a pressure accumulator arranged thereto and comprising at least a gas piston and a gas space,
the gas piston is arranged to separate the second hydraulic pressure fluid chamber and the gas space from one another,
the gas piston is arranged to move in the longitudinal direction of the inner tube according to pressures acting on the hydraulic pressure fluid chamber and the gas space.
and wherein the hydraulic piston and the gas piston are provided with end-cushioning.
